(19) United States
(12) Patent Application Publication
(10) Pub. No.: US 2024/0009745 A1
(43) Pub. Date: Jan. 11, 2024

(54) Tool and Method for Chip-Removing Deburring and/or Chamfering of a Workpiece Toothing Comprising a Plurality of Workpiece Teeth

(71) Applicant: PrâWema Antriebstechnik GmbH, Eschwege/Werra (DE)

(72) Inventors: Jörg Schieke, Erfurt-Marbach (DE); Ralf Painczyk, Nentershausen (DE); Walter Holderbein, Eschwege (DE); Jörg Reinhardt, Berka v.d.H. (DE)

(21) Appl. No.: 18/220,037

(22) Filed: Jul. 10, 2023

(30) Foreign Application Priority Data
Jul. 11, 2022 (DE) 10 2022 117 192.2

(51) Int. Cl. B23F 23/12; B23F 19/10

(52) U.S. Cl. CPC B23F 23/12; B23F 19/10

(57) ABSTRACT

Described and illustrated is a tool for chip-removing deburring and/or chamfering of a workpiece toothing including a plurality of workpiece teeth, having a plurality of cutting edges for chip-removing deburring and/or chamfering of workpiece edges, in particular front edges, of the workpiece toothing each extending between a tooth flank and a front side of a workpiece tooth, the cutting edges arranged distributed around a tool rotation axis of the tool and each having an extension along the tool rotation axis. In order that the compromise between low manufacturing costs and long tool service life can be improved, it is provided that the cutting edges are formed by tool teeth of at least one tool toothing of the tool.

### CROSS-REFERENCE TO RELATED APPLICATION

This application claims priority to German Patent Application No. 10 2022 117 192.2 filed Jul. 11, 2022, the disclosure of which is hereby incorporated by reference in its entirety.

### BACKGROUND OF THE INVENTION

### Field of the Invention

The invention relates to a tool for chip-removing deburring and/or chamfering of a workpiece toothing comprising a plurality of workpiece teeth, having a plurality of cutting edges for chip-removing deburring and/or chamfering of workpiece edges, in particular front edges, of the workpiece toothing each extending between a tooth flank and a front side of a workpiece tooth, the cutting edges arranged distributed around a tool rotation axis of the tool and each having an extension along the tool rotation axis. In addition, the invention relates to a method for chip-removing deburring and/or chamfering of a workpiece toothing of a workpiece comprising a plurality of workpiece teeth with at least one such tool.

### Description of Related Art

Workpiece toothings of workpieces, for example in the form of gear wheels or gear racks, are often produced by means of chip-removing machining methods, such as hobbing or skiving. In the course of this, in the area of the front sides of the workpiece teeth of the workpiece toothing, burrs and sharp workpiece edges typically occur, which are usually undesirable and therefore have to be removed. For this purpose, tools for the forming deburring and chamfering of workpiece toothings, for example in the form of pressing wheels, are used in practice. With such tools, chamfers can be produced on the workpiece edges by forming and thereby the burrs formed on the workpiece edges can be removed.

In addition, tools for chip-removing deburring and/or chamfering of workpiece toothings are known. Such tools typically have a plurality of cutting edges with which the workpiece edges of the workpiece toothing each extending between a tooth flank and a front side of a workpiece tooth can be deburred and/or chamfered in a chip-removing manner. The cutting edges are typically arranged distributed around a tool rotation axis about which the tool rotates during the chip-removing machining. In addition, the cutting edges often have an extension along the tool rotation axis. Respective cutting edges are typically formed by separate cutting plates, which are mounted on a carrier element of the tool.

In practice, tools for chip-removing deburring and/or chamfering of workpiece toothings have to meet different, partly conflicting requirements. On the one hand, there is a need to reduce the effort and cost of manufacturing the tools. On the other hand, the tools should be as wear-resistant as possible to enable a long service life. With the known tools, this conflict of objectives between low manufacturing costs and long tool service life is not yet satisfactorily resolved.

### SUMMARY OF THE INVENTION

Therefore, the present invention is based on the task of designing and further developing the tool and the method in each case of the type mentioned at the beginning and explained in more detail above such that the compromise between low manufacturing costs and long tool service life can be improved.

This task is solved in a tool as described herein in that the cutting edges are formed by tool teeth of at least one tool toothing of the tool.

Said task is further solved as described herein by a method for chip-removing deburring and/or chamfering of a workpiece toothing of a workpiece comprising a plurality of workpiece teeth with at least one tool as described herein,
in which the tool is rotated about the tool rotation axis with engagement of the tool toothing in the workpiece toothing, and
in which with the cutting edges of the tool toothing engaging in the workpiece toothing, the workpiece edges, in particular front edges, of the workpiece toothing each extending between a tooth flank and a front side of a workpiece tooth are at least in sections deburred and/or chamfered in a chip-removing manner.

The tool thus has at least one tool toothing, the tool teeth of which form the cutting edges. In this way, the tool can be provided with a relatively large number of cutting edges in a constructionally simple and cost-effective manner. With a large number of cutting edges, the individual cutting edges are less intensively stressed during the chip-removing machining and consequently wear less quickly, so that the tool service life is extended. In this way, ultimately the manufacturing costs can be reduced while the tool service life remains at least the same and/or the tool service life can be extended while the manufacturing costs remain at most the same.

With regard to a simple and cost-effective manufacture of the tool, it can be useful if the tool teeth of the tool toothing each form at least one of the cutting edges. Alternatively or additionally, the tool toothing can be designed circumferentially around the tool rotation axis. This can be useful in terms of efficient machining of the workpiece.

The tool is designed for chip-removing deburring and/or chamfering of a workpiece toothing which comprises a plurality of workpiece teeth. In principle, deburring can mean the cutting off of at least one burr. Alternatively or additionally, chamfering can mean in principle the creation of at least one chamfer.

The tool comprises the plurality of cutting edges. The cutting edges are designed such that with the cutting edges workpiece edges, in particular front edges, of the workpiece toothing can be deburred and/or chamfered in a chip-removing manner, which each extend between a tooth flank of one of the workpiece teeth and a front side of the respective workpiece tooth. The cutting edges can simply and expediently each be designed at least substantially rectilinear.

The cutting edges are arranged distributed around the tool rotation axis about which the tool can be rotated during the deburring and/or chamfering of the workpiece toothing. The cutting edges can simply and expediently be arranged at least substantially evenly distributed around the tool rotation axis. Then, the distances between the cutting edges can be at least substantially equal. However, an even distribution is not absolutely necessary.

In addition, the cutting edges each have a, in particular not insignificant, extension along the tool rotation axis. Thus, in particular, the cutting edges do not extend substantially in a plane perpendicular to the tool rotation axis. The extension of the cutting edges along the tool rotation axis enables efficient and precise chip-removing machining of the workpiece edges in a kinematically simple manner.

In order to deburr and/or chamfer the workpiece toothing with the tool in a chip-removing manner, the tool is rotated about the tool rotation axis, with the tool toothing engaging in the workpiece toothing. Thus, during rotation of the tool about the tool rotation axis, the tool teeth can engage successively in tooth gaps between the workpiece teeth. Irrespective of this, with the cutting edges of the tool toothing engaging in the workpiece toothing, the workpiece edges of the workpiece toothing, which each extend between a tooth flank and a front side of one of the workpiece teeth, are deburred and/or chamfered in a chip-removing manner at least in sections, in particular at least substantially.

The method can be carried out simply and expediently by means of a machine tool. Then, the tool can be rotationally driven about the tool rotation axis by a tool rotary drive of the machine tool. Alternatively or additionally, the workpiece can be driven by a workpiece drive, for example workpiece rotary drive, of the machine tool. The tool rotary drive and the workpiece drive can be coupled to each other, in particular electronically. Then, the tool and the workpiece can be driven in axis coupling, so that preferably a rotation of the tool about the tool rotation axis causes a movement of the workpiece, for example a rotation of the workpiece about a workpiece rotation axis, or vice versa. In this way, the tool and the workpiece can for example be rotationally driven in a simple manner in an at least substantially constant speed ratio with respect to each other.

In principle, it can be preferable if the workpiece edges are each formed by a tooth flank and a front side of a workpiece tooth. Then, the workpiece edges can each delimit both the tooth flank and the front side. Respective workpiece edges frequently have to be deburred and/or chamfered in practice, so that the advantages of the invention are particularly effective. For the same reason, the workpiece edges can alternatively or additionally be designed as front edges.

For the sake of better comprehensibility and to avoid unnecessary repetition, the tool and the method are described together below without distinguishing in detail between the tool and the method in each case. For the person skilled in the art, however, it is evident from the context which feature is particularly preferred in each case with regard to the tool and/or the method.

According to a first preferred embodiment of the tool, the tool toothing has at least five tool teeth, each of which can form at least one of the cutting edges. This enables a particularly long service life of the tool in a simple and cost-effective manner. This applies all the more if the tool toothing has at least ten, preferably at least fifteen, tool teeth, each of which forms at least one of the cutting edges. Against this background, it is particularly preferred if the tool toothing has at least twenty tool teeth each forming at least one of the cutting edges.

Regardless of the number of tool teeth, the cutting edges can each have a, in particular not insignificant, extension in the circumferential direction of the tool rotation axis. This has a positive effect on a machining of the workpiece edges that is easy to realize kinematically. In this context, it can be additionally useful if the cutting edges are each arranged at a cutting edge angle of at least 20°, preferably at least 30°, in particular at least 40°, and/or at most 70°, preferably at most 60°, in particular at most 50°, to the tool rotation axis. A cutting edge angle of at least substantially 45° can be particularly preferred.

Alternatively or in addition to an extension in the circumferential direction, the cutting edges can simply and expediently be arranged at least substantially on a cylinder shell surface and/or cone shell surface extending around the tool rotation axis. Then, moreover, the cutting edges can each extend at least substantially in the cylinder shell surface and/or the cone shell surface. The cylinder shell surface and/or the cone shell surface can, for example, be an imaginary surface. However, it is preferred if the tool comprises the cylinder shell surface and/or the cone shell surface.

It can contribute to a simple and thus cost-effective construction of the tool if the tool toothing is designed as front toothing. Then, the tool toothing can extend in a simple manner at least substantially in a plane arranged perpendicular to the tool rotation axis. However, this is not absolutely necessary.

Alternatively or in addition to a design as front toothing, it can be suitable if the projections of the tool teeth onto a projection plane arranged perpendicular to the tool rotation axis each extend at least substantially radially to the tool rotation axis. This can also contribute to a simple and cost-effective construction. A particularly simple and cost-effective construction is made possible if the tool teeth each extend at least substantially radially with respect to the tool rotation axis. Irrespective of this, a projection onto the projection plane means in particular a projection perpendicular onto the projection plane.

Alternatively or in addition to a radial arrangement of the tool teeth, it can be constructionally simple and expedient if the cutting edges each extend between a tooth flank of one of the tool teeth and a front side of the respective tool tooth. It can be particularly simple and expedient if the cutting edges are each formed by the tooth flank and the front side of the tool tooth. Then, the cutting edges can each delimit both the tooth flank and the front side of the tool tooth in sections. Irrespective of this, the respective front sides of the tool teeth can each be arranged radially outside with respect to the tool rotation axis. In this way, the cutting edges can be brought into engagement with the workpiece edges to be machined in a simple manner.

For cost reasons, for example, the tool teeth can each have only one cutting edge. However, it is preferred if the tool teeth each have two cutting edges with which mutually opposite workpiece edges of the workpiece teeth can be deburred and/or chamfered. This enables simple and fast machining of the mutually opposite workpiece edges in a single clamping. In this context, mutually opposite workpiece edges can mean in particular workpiece edges that are assigned to mutually opposite tooth flanks and to the same front side of one of the workpiece teeth. Irrespective of this, the cutting edges of a tool tooth can simply and expediently be assigned to different tooth flanks of the tool tooth, in particular be formed by different tooth flanks of the tool tooth.

The tool teeth can each have an at least substantially axisymmetric cross-section at least in the region of the at least one cutting edge. This enables simple and thus cost-effective manufacture of the tool toothing. If the tool teeth each have two cutting edges, the axisymmetric cross-section also enables uniform machining of the mutually opposite workpiece edges, for example of straight-toothed workpieces, in a kinematically simple manner. Then, expediently, the two cutting edges of each tool tooth can be designed at least substantially axisymmetric to each other. Irrespective of this, an axisymmetric cross-section can in particular mean a cross-section which is axisymmetric with respect to an axis of symmetry at least substantially parallel to the tool rotation axis.

As an alternative to an axisymmetric cross-section, the tool teeth can each have an asymmetrical cross-section at least in the area of the at least one cutting edge. This can be useful with regard to kinematically simple machining of, for example, helical toothings and/or workpiece toothings with narrow tooth gaps. In this context, an asymmetrical cross-section can be understood to mean in particular one that is designed asymmetrical with respect to an axis that, in particular, is at least substantially parallel to the tool rotation axis. Irrespective of this, in the case of two cutting edges per tool tooth, it can be expedient if the cutting edges of each tool tooth are designed asymmetrically with respect to one another. Alternatively or additionally, it can be particularly useful in terms of kinematically simple machining if the mutually opposite tooth flanks of the tool teeth each have different tooth flank widths at least in the region of the at least one cutting edge of the respective tool tooth.

The tool can have two tool toothings that are spaced apart from each other along the tool rotation axis. Then, with the tool toothings, workpiece edges that are assigned to different front sides of the workpiece toothing can be simultaneously deburred and/or chamfered. In this way, particularly short machining times can be achieved. The tool toothings can simply and expediently face each other. Alternatively or additionally, it can also be useful if the tool toothings are designed at least substantially identically.

To enable collision-free machining of the workpiece edges up to the tooth base area of the workpiece teeth, it can be useful if the tool teeth each taper to a point at least in one cross-section in the area of the at least one cutting edge at the tooth head of the respective tool tooth. Then, the tooth heads of the tool teeth are preferably not flattened or rounded at least in the region of the cutting edges. Rather, the tooth heads of the tool teeth can each be designed at least substantially line-shaped at least in the region of the at least one cutting edge. Irrespective of this, it can be suitable in terms of a stable design of the tool teeth if the tool teeth each taper to a tooth tip angle of at least 30°. For the same reason, tool teeth that taper to a tooth tip angle of at least 50°, preferably at least 70°, are particularly preferred. Alternatively or additionally, it can be advantageous for constructional reasons if the tool teeth each taper to a tooth tip angle of at most 150°. A particularly simple construction is made possible with tool teeth that taper to a tooth tip angle of at most 130°, preferably at most 110°.

In order to be able to easily clamp the tool in a tool holder, for example of the machine tool, the tool can comprise a clamping section. Then, the tool toothing can face the clamping section. This can be useful with regard to the dissipation of the forces acting on the tool toothing during workpiece machining and, consequently, to low vibration workpiece machining.

In principle irrespective of a clamping section, the tool can expediently comprise a carrier element that carries the at least one tool toothing. The tool toothing can be held removably at the carrier element. In this way, the tool toothing can be replaced, for example, when the wear limit is reached. Irrespective of this, the carrier element can expediently extend along the tool rotation axis. Alternatively or additionally, the carrier element can comprise the clamping section.

With regard to clean cut edges as well as a low energy input into the workpiece and consequently a high workpiece quality, it can be useful if the cutting edges have an edge radius of at most 0.2 mm. Against the same background, it is particularly preferred if the edge radius of the cutting edges is at most 0.1 mm, preferably at most 0.05 mm. Alternatively or additionally, with regard to the effort for preparing the cutting edges and consequently the manufacturing costs, it can be preferred if the cutting edges have an edge radius of at least 0.01 mm, preferably at least 0.02 mm. In this context, the values for the edge radius can expediently refer to the new condition of the tool.

With regard to a long service life of the tool, it can be advantageous if the tool toothing, at least in the area of the cutting edges, has a hardness of at least 60 HRC. For the same reason, it can be even more useful if the hardness is at least 63 HRC, preferably at least 66 HRC. Alternatively or additionally, the tool toothing can have a hardness of at most 68 HRC for cost reasons. In this context, the hardness is measured in particular according to DIN EN ISO 6508-1:2016-12.

The tool toothing can, for example, be formed at least substantially from a powder metallurgically manufactured high-speed steel and/or a hard metal material. Powder metallurgically manufactured high-speed steel is often referred to in practice as “PM-HSS” or “HSS-PM”. In terms of their properties, respective materials are particularly suitable for tool toothing. The aforementioned hardness specifications for the tool toothing are particularly suitable if the tool toothing is formed from a powder metallurgically manufactured high-speed steel. However, in principle, the hardness specifications can also apply to other materials.

According to a preferred embodiment of the method, the workpiece is designed as a gear wheel. Gear wheels can be deburred with the tool in a particularly simple manner. The gear wheel can be an externally toothed gear wheel, for example. Then, the workpiece toothing can be an external toothing. However, it can be particularly preferred if the gear wheel is an internally toothed gear wheel. When deburring and/or chamfering internally toothed gear wheels, special requirements are placed on the tool due to the space conditions, which is why the advantages of the invention are particularly effective. If the workpiece is an internally toothed gear wheel, the workpiece toothing can expediently be an internal toothing.

Irrespective of a design of the workpiece as a gear wheel, it can be useful in terms of a kinematically simple implementation of the deburring and/or chamfering if the workpiece is rotated about a workpiece rotation axis while the workpiece is in engagement with the tool. Then, the workpiece can be rotated about the workpiece rotation axis during the deburring and/or chamfering of the workpiece edges by the tool. Irrespective of this, the workpiece can be rotationally driven about the workpiece rotation axis by a workpiece rotary drive, for example of the machine tool, for the sake of simplicity. Alternatively or additionally, it can be useful if the workpiece rotation axis is arranged at least substantially parallel to the tool rotation axis. This can be kinematically simple and thus have a positive effect on the machine effort. Irrespective of the orientation of the workpiece rotation axis, it can be simple and expedient if the workpiece and the tool are rotated about the respective rotation axis in an at least substantially constant speed ratio.

With regard to efficient machining of the workpiece and consequently a short machining time, it can be useful if consecutive workpiece teeth of the workpiece toothing are deburred and/or chamfered with consecutive tool teeth of the tool toothing. Then, with the cutting edges of adjacently arranged tool teeth, the workpiece edges of adjacently arranged workpiece teeth can be deburred and/or chamfered.

Alternatively or additionally, it can also contribute to a short machining time if, during one rotation of the workpiece about the workpiece rotation axis, at least one workpiece edge of each workpiece tooth of the workpiece toothing is deburred and/or chamfered at least in sections with the tool toothing. Then, the workpiece preferably does not have to be rotated several times about the workpiece rotation axis in order to machine each workpiece tooth at least partially. Irrespective of this, particularly short machining times can be achieved if, during one rotation of the workpiece, not only a section of the workpiece edges, but the workpiece edges are at least substantially deburred and/or chamfered.

With regard to simple kinematics and thus low machine effort, it can be preferred if the cutting edges are each moved in the direction of the tooth base of the workpiece tooth to be machined in each case along the workpiece edge to be machined in each case. Then, while the cutting edges are in chip-removing contact with one of the workpiece edges, the cutting edges can be moved along the workpiece edge in the direction of the tooth base of the workpiece tooth forming the respective workpiece edge.

Regardless of the direction in which the workpiece edges are machined, it can be sufficient in principle if only a section of the workpiece edge to be machined in each case is machined during one rotation of the tool about the tool rotation axis with the tool teeth. However, with regard to a short machining time, it is preferred if, during one rotation of the tool about the tool rotation axis, with the tool teeth in each case the workpiece edge to be machined is deburred and/or chamfered at least substantially from the tooth head of the workpiece tooth to be machined to at least substantially the tooth base of the respective workpiece tooth. Particularly short machining times can be achieved if the workpiece edge to be machined in each case is deburred and/or chamfered at least substantially from the tip circle to at least substantially the root circle of the workpiece toothing. Alternatively or additionally, it can be expedient in this context if the cutting edges, while the cutting edges are in chip-removing contact with one of the workpiece edges, are moved along the workpiece edge at least substantially from the tooth head to at least substantially the tooth base of the workpiece tooth forming the respective workpiece edge.

It can be expedient to deburr and/or chamfer mutually opposite workpiece edges of the workpiece teeth. This can be done, for example, with different tool toothings, for example of the same tool or different tools. However, with regard to short cycle times, it is preferred if mutually opposite workpiece edges of the workpiece teeth are deburred and/or chamfered with the same tool toothing. This is because then, the deburring and/or chamfering of the mutually opposite workpiece edges can be carried out easily and quickly in a single clamping and preferably at least substantially without renewed positioning of the tool. Irrespective of this, it can be expedient if the tool teeth of the tool toothing each comprise two cutting edges for deburring and/or chamfering the mutually opposite workpiece edges. Quite basically, mutually opposite workpiece edges of the workpiece teeth are understood to mean in particular workpiece edges that are assigned to mutually opposite tooth flanks of a workpiece tooth and to the same front side of the workpiece tooth.

Irrespective of whether mutually opposite workpiece edges are machined with the same or different tool toothings, it can be useful if the tool is rotated about the tool rotation axis in opposite directions of rotation during the deburring and/or chamfering of mutually opposite workpiece edges of the workpiece teeth. This also contributes to kinematically simple deburring and/or chamfering of the opposite workpiece edges, which can have a positive effect on the machine effort. Then, for example, first workpiece edges of the workpiece teeth can be machined first, with the tool being rotated about the tool rotation axis in a first direction of rotation. Thereafter, second workpiece edges of the workpiece teeth opposite the first workpiece edges can be machined, with the tool being rotated about the tool rotation axis in a second direction of rotation opposite the first direction of rotation. Irrespective of the direction of rotation of the tool, it may also be useful for the sake simplicity if the workpiece is moved in opposite directions during the deburring and/or chamfering of the mutually opposite workpiece edges, in particular rotated in opposite directions of rotation about the workpiece rotation axis.

With regard to short machining times, it can be advantageous if workpiece edges that are assigned to different front sides of the workpiece toothing are deburred and/or chamfered simultaneously. This can be done with different tools, for example. However, it can be particularly simple if the simultaneous machining of the workpiece edges assigned to the different front sides of the workpiece toothing is carried out with the same tool, preferably with different tool toothings of the same tool, in particular spaced apart from each other along the tool rotation axis.

### BRIEF DESCRIPTION OF THE DRAWINGS

The invention is explained in more detail below by means of a drawing showing only an exemplary embodiment. In the drawing,

FIG. 1A-B show schematically a tool according to the invention during deburring and chamfering of a workpiece toothing of a workpiece in a perspective view and a side view,

FIG. 2A-C show schematically a tool element of the tool from FIG. 1 forming a tool toothing in a perspective view from above, a perspective view from below and a side view,

FIG. 3A-B show schematically a detail of the tool and the workpiece from FIG. 1 with opposite directions of rotation of the tool and the workpiece in each case in the area III shown in FIG. 1A in a perspective view.

### DESCRIPTION OF THE INVENTION

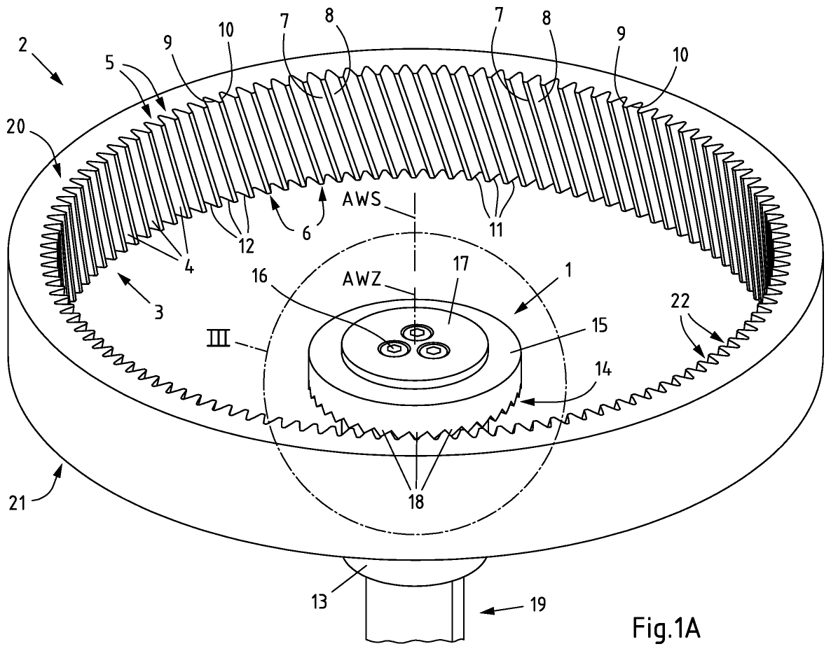

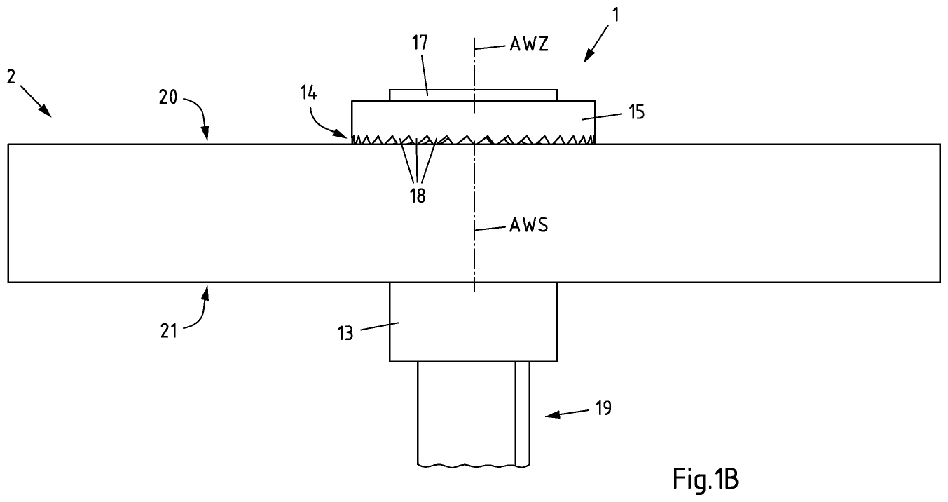

In FIGS. 1A-B, a tool 1 and a workpiece 2 are shown in a perspective view and in a side view. The workpiece 2 is designed as an internally toothed gear wheel, which comprises a in the present case helical toothed workpiece toothing 3 with a plurality of workpiece teeth 4. The workpiece teeth 4 each comprise two front sides 5, 6 and two mutually opposite tooth flanks 7, 8 extending from one front side 5 to the other front side 6. The workpiece teeth 4 each comprise two mutually opposite workpiece edges 9, 10, 11, 12, designed in the present case as front edges, at the front sides 5, 6, which workpiece edges 9, 10, 11, 12 each extend between one of the front sides 5, 6 and one of the tooth flanks 7, 8 of the respective workpiece tooth 4.

The tool 1 comprises a carrier element 13 extending along a tool rotation axis AWZ and a tool element 15 forming a tool toothing 14. The carrier element 13 carries the tool element 15. The tool element 15 is removably mounted at the carrier element 13 in the present case by means of screws 16 and a mounting disk 17. The tool toothing 14 comprises a plurality of tool teeth 18, which are arranged distributed around the tool rotation axis AWZ.

At the longitudinal end opposite the tool element 15, the carrier element 13 comprises a clamping section 19 with which the tool 1 is clamped in a not shown tool holder of a not shown machine tool. Via the tool holder, the tool 1 is rotationally driven about the tool rotation axis AWZ by a not shown tool rotary drive of the machine tool.

The workpiece 2 is clamped in a not shown workpiece holder of the machine tool. Via the workpiece holder, the workpiece 2 is rotationally driven by a not shown workpiece rotary drive of the machine tool about a workpiece rotation axis AWS at least substantially parallel to the tool rotation axis AWZ and arranged centrally of the workpiece 2.

While the tool 1 and the workpiece 2 are rotated about the respective rotation axis AWZ, AWS at an at least substantially constant speed ratio, the tool toothing 14 engages in the workpiece toothing 3 in a rolling manner. In the course of this, the tool teeth 18 engage in tooth gaps 22 between the workpiece teeth 4 via a plane defined by the upper of the two front sides 20,21 of the workpiece toothing 3. The tool teeth 18 engaging in the tooth gaps 22 of the workpiece toothing 3 remove material from the workpiece 2 in the area of the upper front side 20 of the workpiece toothing 3 in a chip-removing manner.

For the sake of simplicity, the tool 1 shown and preferred in this respect comprises only one tool toothing 14, with which the front sides 20,21 of the workpiece toothing 3 can be machined one after the other if required. Alternatively, it could be provided that the tool 1 comprises two tool toothings 14 spaced apart from each other along the tool rotation axis AWZ, for example each formed by a tool element 15. Then, the different front sides 20,21 of the workpiece toothing 3 could be machined simultaneously with the tool 1.

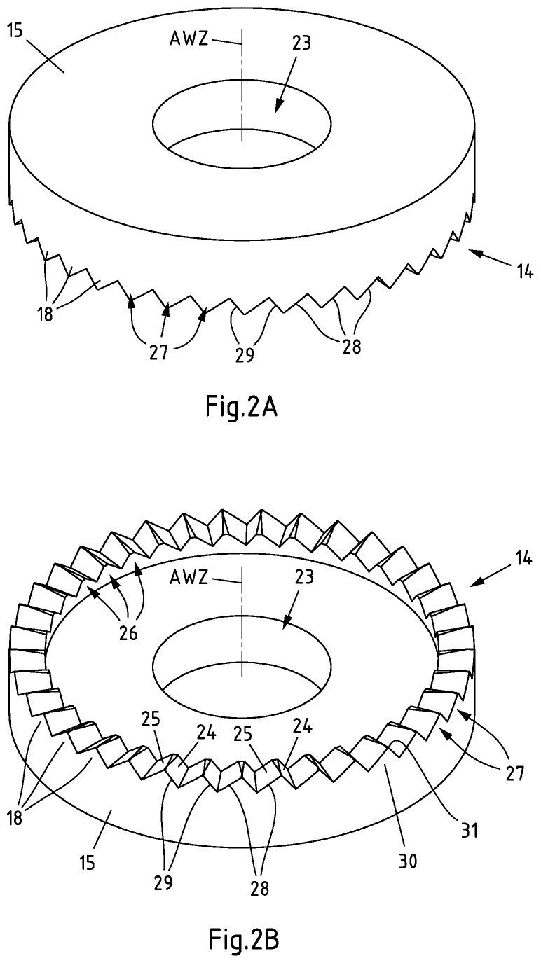

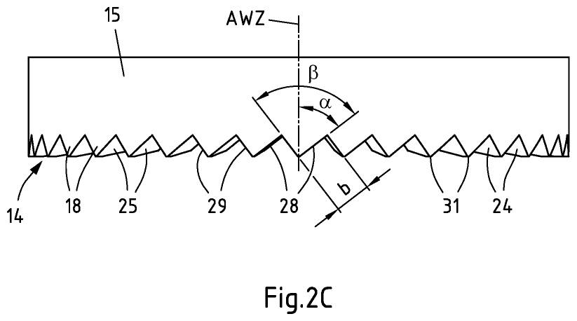

In FIGS. 2A-B, the tool element 15 forming the tool toothing 14 is shown in a perspective view from above and in a perspective view from below. The tool element 15 comprises a mounting opening 23, with which the tool element 15 can be slid onto the carrier element 13 of the tool 1 and fastened there by means of the mounting disk 17 and the screws 16.

In the present case, the tool toothing 14 is designed as a front toothing that extends at least substantially in a plane perpendicular to the tool rotation axis AWZ. The tool teeth 18 each extend at least substantially radially to the tool rotation axis AWZ. The tool teeth 18 each comprise two opposite tooth flanks 24, 25 as well as a front side 26 arranged radially inside and a front side 27 arranged radially outside.

In the illustrated and thus preferred embodiment, the tool teeth 18 each comprise two opposite cutting edges 28,29, which are each formed in the present case by the front side 27 arranged radially outside and one of the tooth flanks 24,25 of the respective tool tooth 18. The cutting edges 28,29 each have an extension along the tool rotation axis AWZ and an extension in the circumferential direction of the tool rotation axis AWZ. In the present case, the cutting edges 28,29 extend in a common cylinder shell surface around the tool rotation axis AWZ. In the illustrated and thus preferred embodiment, the tool teeth 18 each taper continuously from the tooth base 30 in the direction of the tooth head 31 of the respective tool tooth 18. The tool teeth 18 each taper to a point in the region of the cutting edges 28,29 at the tooth head 31.

In FIG. 2C, the tool element 15 forming the tool toothing 14 is shown in a side view. In the present case, the tool teeth 18 each have an asymmetrical cross-section with respect to an axis parallel to the tool rotation axis AWZ. The tooth flanks 25 of the tool teeth 18 each have a larger tooth flank width b in the region of the cutting edges 28,29 than the opposite tooth flank 24 of the respective tool tooth 18. In the tool toothing 14 shown and preferred in this respect, the cutting edges 28 of the tool teeth 18 are arranged at a cutting edge angle α of approximately 50° to the tool rotation axis AWZ. The opposite cutting edges 29 of the tool teeth 18 are arranged in the present case at a cutting edge angle of approximately 40° to the tool rotation axis AWZ. The tool teeth 18 each taper at a tooth tip angle β of at least substantially 90° in the region of the cutting edges 28, 29.

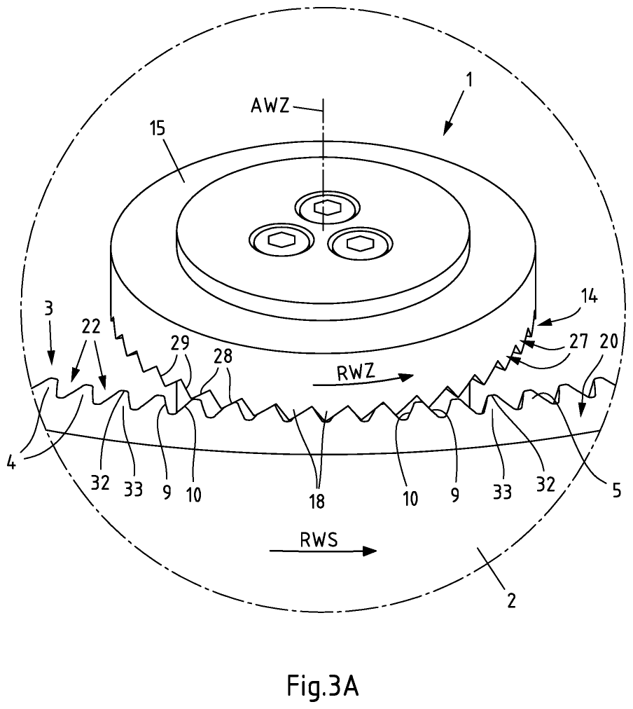

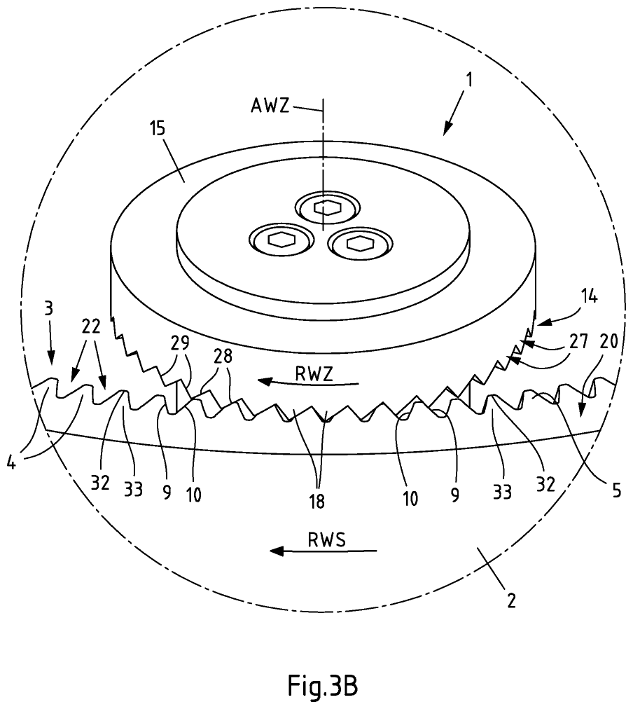

FIG. 3A shows a detail of the tool 1 and the workpiece 2 in the area III shown in FIG. 1A in a perspective view. While the tool 1 and the workpiece 2 are rotated about the respective rotation axis AWZ, AWS, the workpiece edges 10 of the workpiece teeth 4 assigned to the upper front side 20 of the workpiece toothing 3 and trailing in the direction of rotation RWS of the workpiece 2 are deburred and simultaneously chamfered with the cutting edges 28 of the tool teeth 18 leading in the direction of rotation RWZ of the tool 1.

During movement of the tool teeth 18 into the tooth gaps 22 formed between the workpiece teeth 4, the cutting edges 28 leading in the direction of rotation RWZ of the tool 1 come into chip-removing contact with the workpiece edges 10 trailing in the direction of rotation RWS of the workpiece 2. While the cutting edges 28 are in chip-removing contact with the workpiece edges 10 to be machined, the cutting edges 28 are each moved from the tooth head 32 to the tooth base 33 of the respective workpiece tooth 4, so that at least substantially the entire workpiece edge 10 is deburred and chamfered.

In the area of the tooth bases 33 of the workpiece teeth 4, the contact between the tool teeth 18 and the workpiece 2 is removed. During the movement of the tool teeth 18 out of the tooth spaces 22, there is no contact between the cutting edges 29 of the tool teeth 18 trailing in the direction of rotation RWS of the tool 1 and the workpiece edges 9 of the workpiece teeth 4 assigned to the upper front side 20 of the workpiece toothing 3 and leading in the direction of rotation RWS of the workpiece 2. The workpiece edges 9 of the workpiece teeth 4 leading in the direction of rotation RWS of the workpiece 2 thus initially remain unmachined.

In the embodiment shown and preferred in this respect, with the cutting edges 28 of consecutive tool teeth 18, the workpiece edges 10 of consecutive workpiece teeth 4 are machined in a chip-removing manner. In this way, in the present case, during one rotation of the workpiece 2 about the workpiece rotation axis AWS, the workpiece edges 10 of all workpiece teeth 4 trailing in the direction of rotation RWS of the workpiece 2 are deburred and chamfered.

After the workpiece edges 10 of the workpiece teeth 4 have been deburred and chamfered with the cutting edges 28 of the tool teeth 18, the tool 1 and the workpiece 2 are rotated against each other by a small angular amount of, for example, approx. 1°. In this way, the cutting edges 29 of the tool teeth 18 opposite the cutting edges 28 come into contact with the still unmachined workpiece edges 9 of the workpiece teeth 4. Thereafter, the tool 1 and the workpiece 2 are rotated about the respective rotation axis AWZ, AWS in directions of rotation opposite to the directions of rotation RWZ, RWS shown in order to deburr and chamfer the workpiece edges 9 with the cutting edges 29.

In FIG. 3B, the detail of the tool 1 and the workpiece 2 according to FIG. 3A is shown, wherein the tool 1 and the workpiece 2 are rotated against each other by a small angular amount of, for example, approx. 1° compared to the arrangement in FIG. 3A, so that the cutting edges 29 of the tool teeth 18 come into chip-removing contact with the workpiece edges 9 of the workpiece teeth 4. Compared to FIG. 3A, the tool 1 and the workpiece 2 are rotated in opposite directions of rotation RWZ, RWS about the respective rotation axis AWZ, AWS. During movement of the tool teeth 18 into the tooth spaces 22 of the workpiece toothing 3, the cutting edges 29 of the tool teeth 18 leading in the direction of rotation RWZ of the tool 1 come into chip-removing contact with the workpiece edges 9 trailing in the direction of rotation RWS of the workpiece 2. Thereafter, the cutting edges 29 being in chip-removing contact with the workpiece edge 9 to be machined in each case are moved from the tooth head 32 to the tooth base 33 of the respective workpiece tooth 4 along the workpiece edge 9 and in this way the workpiece edges 9 are deburred and chamfered. During movement of the tool teeth 18 out of the tooth gaps 22 of the workpiece toothing 3, there is no contact between the cutting edges 28 of the tool teeth 18 trailing in the direction of rotation RWS of the tool 1 and the workpiece edges 10 of the workpiece teeth 4 leading in the direction of rotation RWS of the workpiece 2.

### LIST OF REFERENCE SIGNS

1 Tool
2 Workpiece
3 Workpiece toothing
4 Workpiece tooth
5,6 Front side of a workpiece tooth
7,8 Tooth flank of a workpiece tooth
9,10,11,12 Workpiece edge
13 Carrier element
14 Tool toothing
15 Tool element
16 Screw
17 Mounting disk
18 Tool tooth
19 Clamping section
20, 21 Front side of the workpiece toothing
22 Tooth gap
23 Mounting opening
24,25 Tooth flank of a tool tooth
26,27 Front side of a tool tooth
28,29 Cutting edge
30 Tooth base of a tool tooth
31 Tooth head of a tool tooth
32 Tooth head of a workpiece tooth
33 Tooth base of a workpiece tooth
AWS Workpiece rotation axis
AWZ Tool rotation axis
RWS Direction of rotation of the workpiece
RWZ Direction of rotation of the tool
b Tooth flank width
α Cutting edge angle
β Tooth tip angle

1. A tool for chip-removing deburring and/or chamfering of a workpiece toothing comprising a plurality of workpiece teeth, having a plurality of cutting edges for chip-removing deburring and/or chamfering of workpiece edges, in particular front edges, of the workpiece toothing each extending between a tooth flank and a front side a workpiece tooth, the cutting edges arranged distributed around a tool rotation axis of the tool and each having an extension along the tool rotation axis,
wherein the cutting edges are formed by tool teeth of at least one tool toothing of the tool.

2. The tool according to claim 1,
wherein the tool toothing comprises at least five, as required at least ten, preferably at least fifteen, in particular at least twenty, tool teeth each forming at least one cutting edge and/or in that the cutting edges each have an extension in the circumferential direction with respect to the tool rotation axis and/or in that the cutting edges are arranged at least substantially on a cylinder shell surface and/or cone shell surface around the tool rotation axis.

3. The tool according to claim 1,
wherein the tool toothing is designed as front toothing and/or in that the projections of the tool teeth onto a projection plane arranged perpendicular to the tool rotation axis each extend at least substantially radially to the tool rotation axis.

4. The tool according to claim 1,
wherein the cutting edges each extend between a tooth flank and a front side of a tool tooth, the front side, in particular, being arranged radially outside with respect to the tool rotation axis.

5. The tool according to claim 1,
wherein the tool teeth each comprise two cutting edges, in particular assigned to different tooth flanks of the tool tooth, for deburring and/or chamfering of mutually opposite workpiece edges of the workpiece teeth.

6. The tool according to claim 1,
wherein the tool teeth each have, at least in the region of the at least one cutting edge, an at least substantially axisymmetric or asymmetrical cross-section.

7. The tool according to claim 1,
wherein the tool comprises two tool toothings spaced apart from one another along the tool rotation axis, in particular facing one another, for simultaneous deburring and/or chamfering of workpiece edges assigned to different front sides of the workpiece toothing.

8. The tool according to claim 1,
wherein the tool teeth each taper at least in one cross-section in the region of the at least one cutting edge at the tooth head of the tool tooth.

9. The tool according to claim 1,
wherein the tool toothing faces a clamping section of the tool for clamping the tool in a tool holder and/or in that a carrier element carrying the at least one tool toothing, in particular extending along the tool rotation axis and/or comprising the clamping section, is provided.

10. The tool according to claim 1,
wherein the cutting edges have an edge radius of at least 0.01 mm, preferably at least 0.02 mm, and/or at most 0.2 mm, preferably at most 0.1 mm, in particular at most 0.05 mm, and/or in that the tool toothing, at least in the region of the cutting edges, has a hardness of at least 60 HRC, preferably at least 63 HRC, in particular at least 66 HRC.

11. A method for chip-removing deburring and/or chamfering of a workpiece toothing of a workpiece comprising a plurality of workpiece teeth with at least one tool according to claim 1,
in which the tool is rotated about the tool rotation axis with engagement of the tool toothing in the workpiece toothing, and
in which with the cutting edges of the tool toothing engaging in the workpiece toothing, the workpiece edges, in in particular front edges, of the workpiece toothing each extending between a tooth flank and a front side of a workpiece tooth are at least in sections deburred and/or chamfered in a chip-removing manner.

12. The method according to claim 11,
in which the workpiece is a, in particular internally toothed, gear wheel and/or
in which the workpiece being in engagement with the tool is rotated about a workpiece rotation axis, which is, in particular, at least substantially parallel to the tool rotation axis.

13. The method according to claim 11,
in which consecutive workpiece teeth of the workpiece toothing are deburred and/or chamfered with consecutive tool teeth of the tool toothing and/or
in which, during one rotation of the workpiece about the workpiece rotation axis, at least one workpiece edge of each workpiece tooth is deburred and/or chamfered at least in sections, in particular at least substantially, with the tool toothing.

14. The method according to claim 11,
in which the cutting edges are each moved in the direction of the tooth base of the workpiece tooth to be machined in each case along the workpiece edge to be machined and/or
in which, during one rotation of the tool about the tool rotation axis, with the tool teeth in each case the workpiece edge to be machined is deburred and/or chamfered at least substantially from the tooth head to at least substantially the tooth base of the workpiece tooth to be machined.

15. The method according to claim 11,
in which mutually opposite workpiece edges of the workpiece teeth are deburred and/or chamfered with the same tool toothing and/or
in which the tool, during deburring and/or chamfering of mutually opposite workpiece edges of the workpiece teeth, is rotated in opposite directions of rotation about the tool rotation axis and/or
in which workpiece edges assigned to different front sides of the workpiece toothing are simultaneously deburred and/or chamfered, in particular with the same tool.
